(19) United States
(12) Patent Application Publication
(10) Pub. No.: US 2025/0102037 A1
(43) Pub. Date: Mar. 27, 2025

(54) TUBULAR VIBRATION DAMPING DEVICE

(71) Applicant: Sumitomo Riko Company Limited, Aichi (JP)

(72) Inventor: Kazuki Hotta, Aichi (JP)

(73) Assignee: Sumitomo Riko Company Limited, Aichi (JP)

(21) Appl. No.: 18/826,126

(22) Filed: Sep. 5, 2024

(30) Foreign Application Priority Data
Sep. 26, 2023 (JP) 2023-163074

(51) Int. Cl. F16F 1/38; B60K 5/12

(52) U.S. Cl. CPC F16F 1/3835; B60G 2204/41; B60K 5/1208

(57) ABSTRACT

A tubular vibration damping device includes an inner shaft member and an outer tube member connected by a main body rubber elastic body. The inner shaft member is provided with a large-diameter part having an outer diameter dimension that is configured to be large at an axial middle portion. The main body rubber elastic body is provided with a through hole penetrating in an axial direction and extending for a predetermined length in a circumferential direction. The through hole has circumferentially opposing inner surfaces at least one of which is provided with an inclined surface that expands such that a circumferentially opposing surface distance gradually increases toward an axial opening part of the through hole.

### CROSS-REFERENCE TO RELATED APPLICATION

This application claims the priority benefit of Japan application serial no. 2023-163074, filed on Sep. 26, 2023. The entirety of the above-mentioned patent application is hereby incorporated by reference herein and made a part of this specification.

### BACKGROUND

### Technical Field

The disclosure relates to a tubular vibration damping device applicable to a suspension bush, a member mount, an engine mount, etc. of an automobile.

### Related Art

Conventionally, a tubular vibration damping device has been known as a type of vibration damping device used in automobiles. As disclosed in Japanese Patent Application Laid-Open No. 2006-153265 (Patent Document 1), a tubular vibration damping device has a structure in which an inner shaft member and an outer tube member are connected by a main body rubber elastic body.

However, in the tubular vibration damping device described in Patent Document 1, through holes penetrating through the main body rubber elastic body in an axial direction are formed on both sides in a radial direction sandwiching the inner shaft member. Accordingly, a low spring property is realized in the radial direction in which the through holes are arranged, and a high spring property is realized in a radial direction in which the through holes are not arranged. Further, in the radial direction in which the through holes are formed, the spring constant in a torsional direction is also configured to be small.

However, in the structure of Patent Document 1, depending on the required spring properties, a magnitude of a spring ratio between two orthogonal directions including the radial direction in which the through holes are formed and the radial direction orthogonal thereto may be insufficient, and a larger spring ratio may be required. In other words, in the tubular vibration damping device of Patent Document 1, if a circumferential length of the through hole is increased to set a small spring constant in an axial-perpendicular direction in the radial direction in which the through holes are formed, a spring reduction effect by the through holes is also exhibited in the radial direction orthogonal to the radial direction in which the through holes are formed, and it becomes difficult to set a large spring constant in this radial direction. Thus, the spring ratio cannot be increased.

Further, if the circumferential length of the through hole is to be increased to set a small spring constant of a torsional direction in the arrangement direction of the through holes, since the spring constant in the axial-perpendicular direction is also reduced, it is difficult to set a small spring constant in the torsional direction while ensuring support spring stiffness in the axial-perpendicular direction, for example.

### SUMMARY

Exemplary aspects for understanding the disclosure will be described below, but the various aspects described below are illustrative and may not only be adopted in combination with each other as appropriate, but multiple components described in each aspect may also be recognized and adopted independently wherever possible and may also be adopted in combination with any component described in another aspect as appropriate. Thus, in the disclosure, various other aspects may be realized without being limited to the aspects described below.

A first aspect is a tubular vibration damping device including an inner shaft member and an outer tube member connected by a main body rubber elastic body. The inner shaft member is provided with a large-diameter part having an outer diameter dimension that is configured to be large at an axial middle portion. The main body rubber elastic body is provided with a through hole penetrating in an axial direction and extending for a predetermined length in a circumferential direction. The through hole has circumferentially opposing inner surfaces at least one of which is provided with an inclined surface that expands such that a circumferentially opposing surface distance gradually increases toward an axial opening part of the through hole.

According to the tubular vibration damping device structured according to this aspect, by providing the large-diameter part at the axial middle portion of the inner shaft member and providing the inclined surface at the circumferentially opposing inner surface of the through hole, it is possible to set a larger ratio between a spring constant in a radial direction in which the through holes are located and a spring constant in a radial direction off the through holes.

Further, by providing the large-diameter part at the axial middle portion of the inner shaft member and providing the inclined surface at the circumferentially opposing inner surface of the through hole, it is possible to set a smaller spring constant in a torsional direction without excessively reducing the spring constant in the axial-perpendicular direction.

According to a second aspect, in the tubular vibration damping device described in the first aspect, the circumferentially opposing surface distance between the circumferentially opposing inner surfaces in the through hole is configured to be minimum at an axial central portion and gradually increases toward both axial sides.

According to the tubular vibration damping device structured according to this aspect, by setting the inclined surface on both axial sides, it becomes easy to set a larger ratio between a spring constant in the radial direction in which the through holes are located and a spring constant in the radial direction off the through holes. Further, a lower spring in the torsional direction can be more advantageously realized while ensuring a spring in the axial-perpendicular direction.

According to a third aspect, in the tubular vibration damping device described in the first or second aspect, at an axial position at which the circumferentially opposing surface distance between the circumferentially opposing inner surfaces in the through hole is minimum, the circumferentially opposing surface distance between the circumferentially opposing inner surfaces is configured to be smaller than an outer diameter of the inner shaft member.

According to the tubular vibration damping device structured according to this aspect, at the axial position at which the circumferentially opposing surface distance between the circumferentially opposing inner surfaces in the through hole is minimum, a compression spring component in the radial direction in which the through holes are located is ensured on circumferential outer sides of the through hole. Thus, it is possible to prevent the spring constant in the radial direction from becoming excessively small. Further, a shear spring component that affects an axial-perpendicular spring constant in the radial direction off the through holes can be ensured at the axial middle to set a large axial-perpendicular spring constant in the radial direction off the through holes.

According to a fourth aspect, in the tubular vibration damping device described in the third aspect, the circumferentially opposing surface distance between the inclined surfaces of the circumferentially opposing inner surfaces in the through hole is configured to be smaller than the outer diameter of the inner shaft member.

According to the tubular vibration damping device structured according to this aspect, by setting the circumferentially opposing surface distance between the inclined surfaces to be smaller than the outer diameter of the inner shaft member, an effect of the through holes on a spring constant in the radial direction off the through holes can be further suppressed to set a larger spring constant in the radial direction off the through holes.

According to a fifth aspect, in the tubular vibration damping device described in any one of the first to fourth aspects, the through hole does not overlap with the inner shaft member in an axial-perpendicular projection from a lateral side.

According to the tubular vibration damping device structured according to this aspect, in an axial-perpendicular projection direction in which the through holes are located away from the inner shaft member without overlapping with the inner shaft member, it is possible to prevent a reduction in the rubber compressed between the inner shaft member and the outer tube member due to the formation of the through holes, and set a large spring constant in the axial-perpendicular projection direction.

According to a sixth aspect, in the tubular vibration damping device described in any one of the first to fifth aspects, the main body rubber elastic body is provided with a pair of the through holes on both sides in a first radial direction with respect to the inner shaft member, and is configured as a solid structure in a second radial direction orthogonal to the first radial direction.

According to the tubular vibration damping device structured according to this aspect, it is possible to set a larger ratio between a spring constant in the first radial direction in which the pair of through holes are located and a spring constant in the second radial direction orthogonal to the first radial direction. Further, by forming the pair of through holes in the main body rubber elastic body, it is possible to set a smaller torsional spring constant in the first radial direction.

According to a seventh aspect, in the tubular vibration damping device described in any one of the first to sixth aspects, a radially opposing surface distance between radially opposing inner surfaces in the through hole is configured to be constant.

According to the tubular vibration damping device structured according to this aspect, the axial-perpendicular spring constant in the radial direction off the through holes can be ensured while setting a small axial-perpendicular spring constant and a small torsional spring constant in the radial direction in which the through holes are located.

According to an eighth aspect, in the tubular vibration damping device described in any one of the first to seventh aspects, a thickness dimension of a portion of the main body rubber elastic body located on an inner circumferential side of the through hole is configured to be constant in the circumferential direction.

According to the tubular vibration damping device structured according to this aspect, stress concentration during deformation of the main body rubber elastic body is suppressed on the inner circumferential side of the through hole, and improvement in durability and the like is achieved.

According to the aspects of the disclosure, in the tubular vibration damping device, it is possible to set a larger spring ratio between the radial direction in which the through holes are located and the radial direction off the through holes, and it is also possible to realize a low spring property in a torsional direction while ensuring a spring in the radial direction.

### BRIEF DESCRIPTION OF DRAWINGS

FIG. 1 is a perspective view showing a suspension bush as a first embodiment of the disclosure.

FIG. 2 is a front view of the suspension bush shown in FIG. 1.

FIG. 3 is a cross-sectional view taken along line III-III in FIG. 2.

FIG. 4 is a cross-sectional view taken along line IV-IV in FIG. 2.

FIG. 5 is a table showing actual measurement results of axial-perpendicular spring property in an up-down direction and a left-right direction for a tubular vibration damping device according to the disclosure.

### DESCRIPTION OF EMBODIMENTS

Embodiments of the disclosure provide a tubular vibration damping device of a novel structure capable of setting a larger spring ratio between a radial direction in which through holes are located and a radial direction off the through holes, and realizing a low spring property in a torsional direction while ensuring a spring in a radial direction.

Hereinafter, embodiments of the disclosure will be described with reference to the drawings.

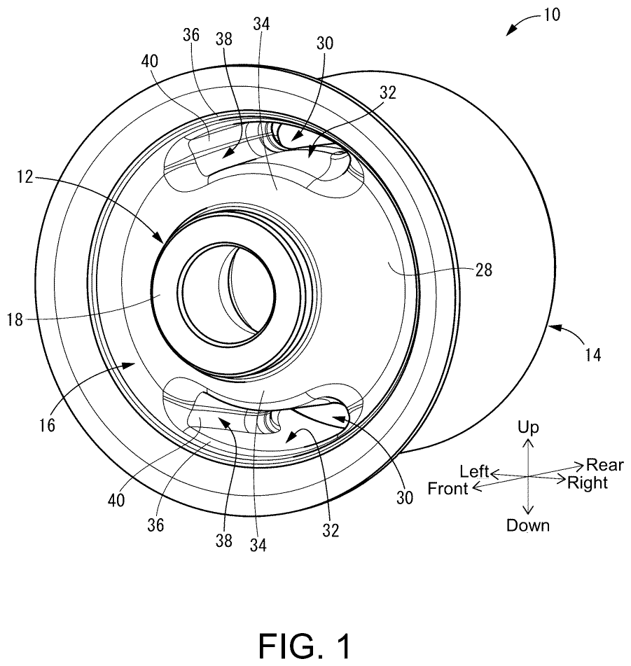

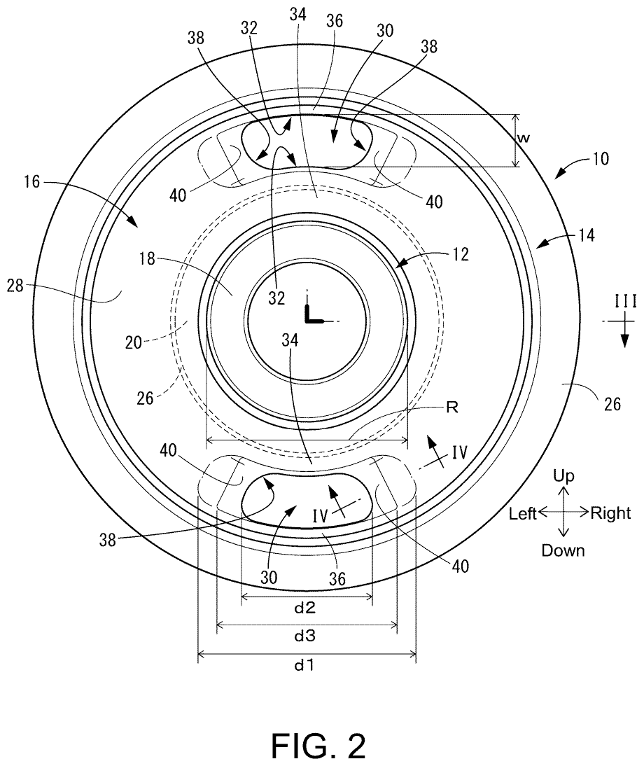

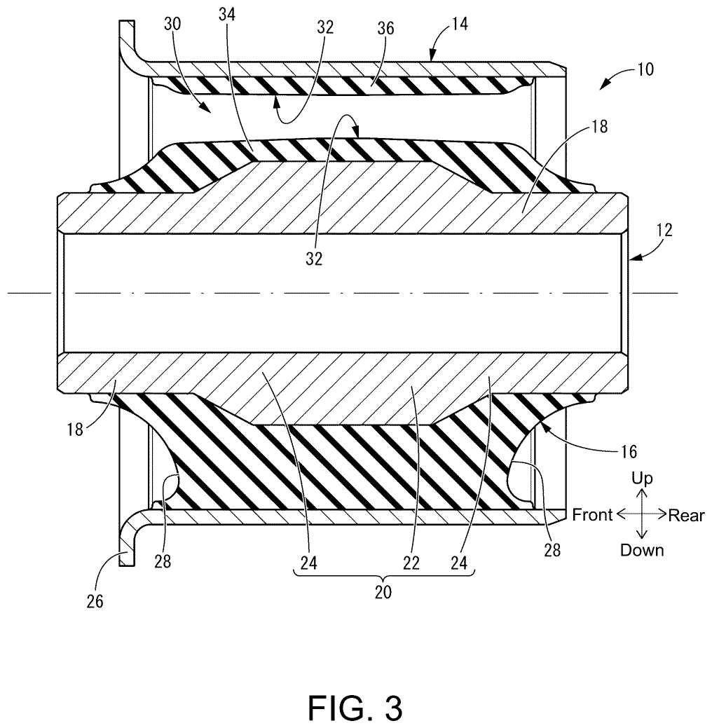

FIG. 1 to FIG. 3 show a suspension bush 10 for an automobile as a first embodiment of a tubular vibration damping device structured according to the disclosure. The suspension bush 10 has a structure in which an inner shaft member 12 and an outer tube member 14 are connected to each other by a main body rubber elastic body 16. In the following description, in principle, an up-down direction refers to an up-down direction in FIG. 2, which is a first radial direction, a left-right direction refers to a left-right direction in FIG. 2, which is a second radial direction, and a front-rear direction refers to a left-right direction in FIG. 3, which is an axial direction.

The inner shaft member 12 is a high-rigidity member formed of a metal such as iron or an aluminum alloy, or a fiber-reinforced synthetic resin, and is configured into a substantially cylindrical shape with a small diameter. As shown in FIG. 3, both end portions of the inner shaft member 12 in the axial direction are respectively configured as a small-diameter part 18 extending in the axial direction with a substantially constant cross-section, and a central portion of the inner shaft member 12 in the axial direction is configured as a large-diameter part 20 having an outer diameter dimension configured to be larger than the small-diameter part 18.

More specifically, a center portion of the large-diameter part 20 in the axial direction is configured as a straight part 22 extending in the axial direction with a substantially constant outer diameter, and both axial sides of the large-diameter part 20 are respectively configured as tapered parts 24 at which the outer diameter gradually decreases toward axial outer sides. However, the large-diameter part 20 is not limited to a shape including the straight part 22 and the tapered parts 24, and may also be configured into a tapered shape in which an outer diameter dimension changes over the entire axial direction, for example, being configured into a substantially semicircular shape in a longitudinal cross-section.

An inner diameter dimension of the large-diameter part 20 in this embodiment is configured to be substantially constant over an entire length. However, for example, the inner diameter dimension may also be changed in the axial direction corresponding to the change in the outer diameter dimension to configure, for example, an inner shaft member 12 having a radial thickness dimension that is substantially constant over the entire length in the axial direction.

The axial length dimension of the large-diameter part 20 may be configured within a range of one fifth to one half with respect to an axial length dimension of the entire inner shaft member 12. A difference in a radius dimension between the large-diameter part 20 and the small-diameter part 18 is not particularly limited, but is configured to be substantially equal to or smaller than a thickness dimension of the small-diameter part 18.

Similar to the inner shaft member 12, the outer tube member 14 is configured as a high-rigidity member, and is configured into a substantially cylindrical shape that is thin and has a large diameter compared to the inner shaft member 12. The outer tube member 14 is configured with inner and outer diameter dimensions that are substantially constant over an entire length in the axial direction.

At an end part (right end part in FIG. 3) of the outer tube member 14 on one axial side, a taper that decreases in diameter toward an edge in a chamfered shape may be provided on an outer circumferential surface and may be configured as, for example, a guide surface for press-fitting or the like. Further, an outer flange part 26 in a circular ring plate shape that bends and spreads toward the outer circumferential side is integrally formed at an end part of the outer tube member 14 on the other axial side.

As shown in FIG. 1 to FIG. 3, the inner shaft member 12 is inserted into an inner circumference of the outer tube member 14, and a main body rubber elastic body 16 is arranged between the inner shaft member 12 and the outer tube member 14 in the radial direction. The main body rubber elastic body 16 is configured into a substantially cylindrical shape that is thick as a whole. An inner circumferential surface of the main body rubber elastic body 16 is vulcanized and adhered to an outer circumferential surface of the inner shaft member 12, and an outer circumferential surface of the main body rubber elastic body 16 is vulcanized and adhered to an inner circumferential surface of the outer tube member 14.

The main body rubber elastic body 16 is fixed to respective axial middle portions of the inner shaft member 12 and the outer tube member 14, and the inner shaft member 12 and the outer tube member 14 protrude toward axial outer sides from the main body rubber elastic body 16. In this embodiment, the inner shaft member 12 is longer in the axial direction than the outer tube member 14, and the inner shaft member 12 protrudes to axial outer sides beyond the outer tube member 14. A protruding amount of the inner shaft member 12 from the main body rubber elastic body 16 toward the axial outer sides and a protruding amount of the outer tube member 14 from the main body rubber elastic body 16 toward the axial outer sides are configured to be substantially the same, and an inner circumferential end of the main body rubber elastic body 16 is located more toward the axial outer sides of an outer circumferential end. The inner circumferential end of the main body rubber elastic body 16 extends to axial outer sides of the large-diameter part 20 of the inner shaft member 12 and is fixed not only to the large-diameter part 20 but also to the small-diameter parts 18 and 18.

Axial end surfaces of the main body rubber elastic body 16 are configured as curved end surfaces 28 with concave cross-sections that open toward the axial outer sides. At the curved end surface 28, a deepest part located on an axial inner-most side is set at a middle in the radial direction and, in this embodiment, is set at a position biased toward the outer circumference from a center in the radial direction.

A pair of through holes 30 and 30 are formed in the main body rubber elastic body 16. The through hole 30 is configured to penetrate the main body rubber elastic body 16 in the axial direction. The pair of through holes 30 and 30 are arranged on both sides in the up-down direction, which is the first radial direction, with respect to the inner shaft member 12. The through hole 30 extends for a predetermined length in the circumferential direction and is configured into a hole cross-sectional shape that curves in the circumferential direction along the outer tube member 14. For example, the circumferential length of the through hole 30 is preferably configured to be one third or less of the circumference, and more preferably one fourth or less of the circumference.

A radial width dimension w of the through hole 30, which is an opposing surface distance between radially opposing inner surfaces 32 and 32 of the through hole 30, is configured to be constant in the circumferential direction as shown in FIG. 2 (dimensional changes to a degree due to manufacturing-related or precision-related reasons are allowed, in a range of being substantially constant in appearance; the same applies hereinafter), and is also configured to be constant in the axial direction as shown in FIG. 3. An inner circumferential rubber 34 located on the inner circumferential side of the through hole 30 in the main body rubber elastic body 16 is configured with a thickness dimension that is constant in the circumferential direction, and extends in the circumferential direction with a constant cross-section in this embodiment. Further, an outer circumferential rubber 36 located on the outer circumferential side of the through hole 30 in the main body rubber elastic body 16 is configured with a thickness dimension that is constant in the circumferential direction, and extends in the circumferential direction with a constant cross-section in this embodiment.

In this embodiment, the pair of through holes 30 and 30 are configured into the same shape (symmetrical shape) as each other. Further, circumferentially opposing inner surfaces 38 and 38 on both circumferential sides of the through hole 30 are configured into the same shape (symmetrical shape) as each other. However, the shapes of the pair of through holes 30 and 30 and the shapes of the circumferentially opposing inner surfaces 38 and 38 of each through hole 30 are not limited to embodiments of being configured into shapes symmetrical to each other.

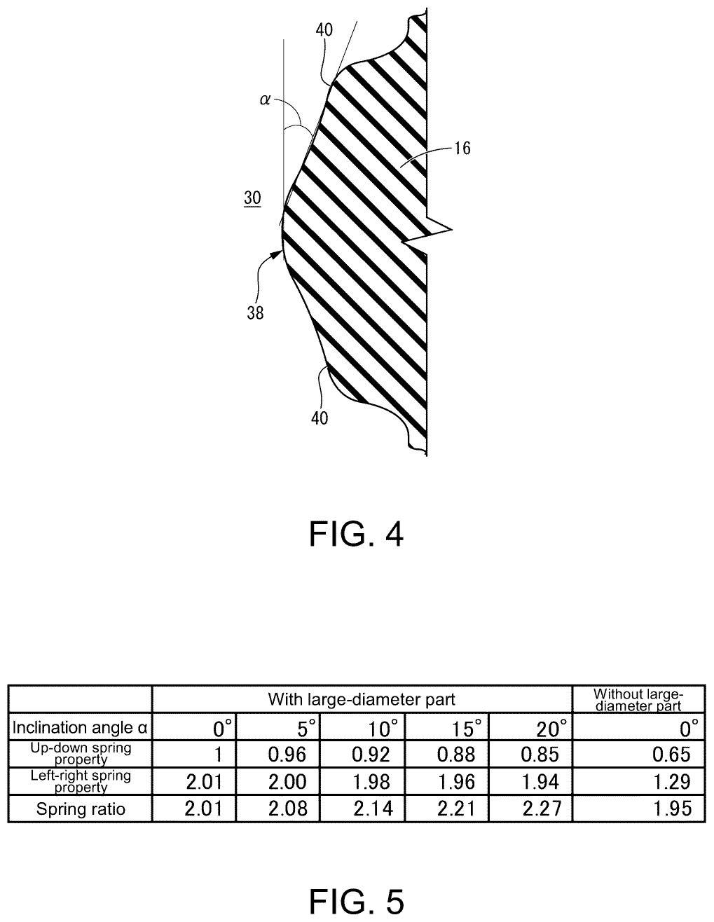

As shown in FIG. 4, the circumferentially opposing inner surface 38 of the through hole 30 includes inclined surfaces 40 and 40. The inclined surface 40 is inclined to expand toward the circumferential outer side, from a central portion in the axial direction toward the axial outer sides (axial opening parts of the through hole 30). Thus, the through hole 30 is configured into an expanding shape having a length dimension in the circumferential direction that changes in the axial direction and a circumferential length that increases toward the axial outer side.

A middle portion in the axial direction of the circumferentially opposing inner surface 38 of the through hole 30 is configured as inclined surfaces 40 and 40 that are inclined at a substantially constant inclination angle α with respect to the axial direction. In other words, in this embodiment, at the circumferentially opposing inner surface 38, the middle portion excluding a central portion and both end portions in the axial direction, at which the inclination angle changes in the axial direction, is configured as the inclined surfaces 40 and 40.

In this embodiment, in each of a region on an axial central side and a region on an axial end side with respect to the inclined surface 40 of the middle portion, an expanding shape is configured in which a length dimension in the circumferential direction of the through hole 30 changes in the axial direction, and a circumferential length increases toward the axial outer side. Then, in the region on the axial central side of the inclined surface 40 of the middle portion, an inclination angle is configured to be smaller than the inclined surface 40, and in the region on the axial end side, an inclination angle is configured to be larger than the inclined surface 40.

The inclination angle of such an inclined surface 40 does not necessarily have to be constant, and may also change gradually or stepwise in the axial direction. In the case where the inclination angle of the inclined surface 40 changes in the axial direction, an inclination angle α of the inclined surface 40 is, for example, configured as a mean or a median of the inclination angles. A magnitude of the inclination angle α of the inclined surface 40 is not particularly limited, but is set, for example, within a range of 1° to 30°, and more preferably within a range of 5° to 20°.

A distance between circumferentially opposing surfaces of the circumferentially opposing inner surfaces 38 and 38 of the through hole 30 is configured to be minimum at an axial center and is configured to be maximum at axial ends. For example, a distance (maximum distance) d1 (straight-line distance, referring to FIG. 2) between circumferentially opposing surfaces of the circumferentially opposing inner surfaces 38 and 38 at the axial end of the main body rubber elastic body 16 is preferably set within a range of 1.2 times to 2 times, and more preferably within a range of 1.4 times to 1.8 times, a distance (maximum distance) d2 between circumferentially opposing surfaces of the circumferentially opposing inner surfaces 38 and 38 at the axial center of the main body rubber elastic body 16. A distance (maximum distance) d3 between circumferentially opposing surfaces of the circumferentially opposing inner surfaces 38 and 38 at an axial end of the inclined surface 40 is configured to be smaller than the distance d1 between circumferentially opposing surfaces of the circumferentially opposing inner surfaces 38 and 38 at the axial end of the main body rubber elastic body 16, and larger than the distance d2 between circumferentially opposing surfaces of the circumferentially opposing inner surfaces 38 and 38 at the axial center of the main body rubber elastic body 16. For example, the distance d3 is preferably configured to be within a range of 1.1 times to 1.6 times the distance d2.

At the axial center at which the circumferential length of the through hole 30 is smallest, the distance d2 between circumferentially opposing surfaces of the circumferentially opposing inner surfaces 38 and 38 is configured to be smaller than an outer diameter dimension R of the inner shaft member 12 (small-diameter part 18), and the circumferentially opposing inner surfaces 38 and 38 overlap with the inner shaft member 12 in a projection in the up-down direction. In this embodiment, at an axial outer end of the inclined surface 40 as well, the distance d3 between circumferentially opposing surfaces of the circumferentially opposing inner surfaces 38 and 38 (inclined surfaces 40 and 40) is configured to be smaller than the outer diameter dimension R of the inner shaft member 12 (small-diameter part 18), and the circumferentially opposing inner surfaces 38 and 38 overlap with the inner shaft member 12 in a projection in the up-down direction. Each inclined surface 40 of the through holes 30 and 30 is provided at a position at which the inclined surface 40 entirely overlaps with the inner shaft member 12 in a projection in the up-down direction. In this embodiment, the distance d1 between circumferentially opposing surfaces of the circumferentially opposing inner surfaces 38 and 38 at the axial end of the main body rubber elastic body 16 is configured to be larger than the outer diameter dimension R of the inner shaft member 12 (small-diameter part 18), but may also be configured to be smaller than the outer diameter dimension R of the inner shaft member 12, for example.

The through holes 30 and 30 do not overlap with the inner shaft member 12 in a projection in the left-right direction, which is a lateral side. The entire through holes 30 and 30 may be spaced apart from the inner shaft member 12 on the outer sides in the up-down direction. Both left and right side portions that overlap with the inner shaft member 12 in a projection in the left-right direction in the main body rubber elastic body 16 have at least a central portion in the axial direction that is configured as a solid structure, and extend continuously in the radial direction between radially opposing surfaces of the inner shaft member 12 and the outer tube member 14. Thus, in the main body rubber elastic body 16, the pair of through holes 30 and 30 are formed to penetrate on both sides in the up-down direction, which is the first radial direction, and both sides in the left-right direction, which is the second radial direction, are configured as a solid structure to continuously connect the inner shaft member 12 and the outer tube member 14 in the radial direction.

With the suspension bush 10 structured in this manner, for example, by attaching the inner shaft member 12 to a suspension member (not shown) serving as a vehicle body side and attaching the outer tube member 14 to a suspension arm (not shown) serving as a wheel side, the suspension arm and the suspension member are connected to each other in a vibration damping manner.

Then, when vibrations are inputted between the inner shaft member 12 and the outer tube member 14 with the suspension bush 10 mounted to a vehicle, a vibration damping effect due to internal friction or the like is exhibited during deformation of the main body rubber elastic body 16.

With the pair of through holes 30 and 30 formed at the main body rubber elastic body 16, a spring constant in the up-down direction of the suspension bush 10 is configured to be smaller than a spring constant in the left-right direction. Thus, during an axial-perpendicular input in the up-down direction, a spring property softer than during an axial-perpendicular input in the left-right direction is exhibited. Accordingly, for example, during an input in the up-down direction due to unevenness on a road surface or the like, a good ride comfort is realized due to the soft spring property, and during an input in the left-right direction such as during turning, excellent traveling stability is exhibited due to the hard spring property.

To effectively satisfy each of a required property for an input in the up-down direction and a required property for an input in the left-right direction described above, a ratio of the spring constant in the left-right direction to the spring constant in the up-down direction may be set to be large. In particular, the spring constant in the left-right direction which affects traveling performance needs to satisfy required values based on vehicle properties, and while satisfying the required values for the spring constant in the left-right direction, the ratio of the spring constant in the left-right direction to the spring constant in the up-down direction may be set to be large. In other words, there may be cases where the spring constant in the up-down direction needs to be set to be small while preventing a decrease in the spring constant in the left-right direction.

Thus, in the suspension bush 10 of this embodiment, the large-diameter part 20 is provided at the axial central portion of the inner shaft member 12, and the inclined surfaces 40 and 40 that are inclined to the circumferential outer side toward the axial outer sides are set on each circumferentially opposing inner surface 38 of the through hole 30. Accordingly, it is possible to set a small spring constant in the up-down direction while suppressing a decrease in the spring constant in the left-right direction to set a larger ratio of the spring constant in the left-right direction to the spring constant in the up-down direction.

That is, at the axial central portion at which the large-diameter part 20 is provided at the inner shaft member 12, the main body rubber elastic body 16 is configured to be thin in the radial direction, and since a shear spring component of the main body rubber elastic body 16 at this portion affects the spring constant in the left-right direction, a decrease in the spring constant in the left-right direction due to the formation of the through hole 30 is suppressed by setting the circumferential length dimension of the through hole 30 to be small.

At an axial outer side portion off from a maximum outer diameter portion of the large-diameter part 20 toward the axial outer side, the main body rubber elastic body 16 is configured to be thick in the radial direction, and a shear spring component of the main body rubber elastic body 16 at this portion has a small effect on the spring constant in the left-right direction. Thus, by providing the inclined surfaces 40 and 40 on each circumferentially opposing inner surface 38 of the through hole 30 and setting the circumferential length dimension of the through hole 30 to increase toward the axial outer side, it is possible to effectively reduce the spring constant by a reduction in the compression spring component in the up-down direction while suppressing a decrease in the spring constant in the left-right direction.

Thus, according to the suspension bush 10 of this embodiment, with the large-diameter part 20 of the inner shaft member 12 provided at the middle portion in the axial direction and the shape of the circumferentially opposing inner surfaces 38 and 38 of each through hole 30, it becomes possible to set a large spring ratio between the spring constant in the up-down direction and the spring constant in the left-right direction while ensuring a sufficiently large spring constant in the left-right direction.

In the suspension bush 10 of this embodiment, the pair of through holes 30 and 30 are provided on both upper and lower sides of the inner shaft member 12, and the main body rubber elastic body 16 is configured as a solid structure, which is continuous radially, in the left-right direction. Accordingly, the spring ratio between the spring constant in the up-down direction and the spring constant in the left-right direction can be set to be larger.

In this embodiment, an opposing surface distance between the circumferentially opposing inner surfaces 38 and 38 is minimum at the axial center of the through hole 30, and the inclined surfaces 40 and 40 are set on both sides in the axial direction. Accordingly, the spring ratio between the spring constant in the up-down direction and the spring constant in the left-right direction can be more efficiently set to be larger compared to the case where the inclined surface 40 is set on one side only.

The distance d2 between the circumferentially opposing inner surfaces 38 and 38 of the through hole 30 at the axial center is configured to be smaller than the outer diameter dimension R of the inner shaft member 12. Accordingly, at the axial center of the main body rubber elastic body 16, the effect of the through hole 30 on the axial-perpendicular spring constant in the left-right direction can be suppressed to obtain a large axial-perpendicular spring constant in the left-right direction.

Furthermore, at the axial outer ends of the inclined surfaces 40 and 40, the distance d3 between the circumferentially opposing inner surfaces 38 and 38 of the through hole 30 is configured to be smaller than the outer diameter dimension R of the inner shaft member 12. Accordingly, the effect of the through hole 30 on the axial-perpendicular spring constant in the left-right direction can be further suppressed to obtain a large axial-perpendicular spring constant in the left-right direction.

In a projection in the left-right direction, the through hole 30 is separated from the inner shaft member 12 on both upper and lower outer sides and does not overlap with the inner shaft member 12. Accordingly, it is possible to prevent a reduction in the compression spring component in the left-right direction of the main body rubber elastic body 16 due to the through hole 30, and the effect of the through hole 30 on the axial-perpendicular spring constant in the left-right direction is suppressed.

Further, in the main body rubber elastic body 16 of the suspension bush 10, with the formation of the through hole 30, a spring constant is set to be small in a torsional direction in which the inner shaft member 12 and the outer tube member 14 relatively tilt in the up-down direction. A circumferential length of the axial outer side portion of the through hole 30 is configured to be large due to the inclined surfaces 40 and 40 provided at the circumferentially opposing inner surface 38. Since rubber is reduced at an axial outer end portion serving as a compression spring component or a tension spring component during up-down torsional displacement between the inner shaft member 12 and the outer tube member 14, a spring constant with respect to a torsional input in the up-down direction is efficiently reduced.

Particularly, at the axial central portion at which the effect on the axial-perpendicular spring constant in the up-down direction is large and the effect on the torsional spring constant is small, the circumferential length of the through hole 30 is configured to be small to ensure the rubber that connects the inner shaft member 12 and the outer tube member 14 in the up-down direction. Thus, the torsional spring constant can be efficiently reduced while ensuring the necessary axial-perpendicular spring constant in the up-down direction. Moreover, the large-diameter part 20 is provided at the axial central portion of the inner shaft member 12, and the compression spring component and the tension spring component are reduced during a torsional displacement between the inner shaft member 12 and the outer tube member 14. Thus, the torsional spring constant can be set to be smaller while ensuring the axial-perpendicular spring constant.

A radially opposing surface distance w between the radially opposing inner surfaces 32 and 32 of the through hole 30 is configured to be constant without increasing partially. Accordingly, in the suspension bush 10, it is easy to ensure a large axial-perpendicular spring constant in the left-right direction while setting a small torsional spring constant in the up-down direction with the formation of the through hole 30.

Further, a thickness dimension of the inner circumferential rubber 34 located on an inner circumference of the through hole 30 is configured to be substantially constant in the circumferential direction. Accordingly, during elastic deformation in the circumferential direction of the inner circumferential rubber 34, it is difficult for stress concentration to occur at the inner circumferential rubber 34, and improvement in durability by stress dispersion may be achieved.

The inventor prepared a suspension bush using an inner shaft member 12 with a large-diameter part 20 and a suspension bush using a straight-shape inner shaft member without a large-diameter part 20, and conducted a test to measure spring properties thereof. The results of such a test are shown in FIG. 5. The table in FIG. 5 shows results of measuring an axial-perpendicular spring property in the up-down direction, an axial-perpendicular spring property in the left-right direction, and a ratio between axial-perpendicular spring constants in the up-down direction and the left-right direction, for each of cases where the inclination angle α (see FIG. 4) of the inclined surface 40 is configured to be 0°, 5°, 10°, 15°, and 20° in the suspension bush with the large-diameter part 20. Further, the table in FIG. 5 shows results of measuring an axial-perpendicular spring property in the up-down direction, an axial-perpendicular spring property in the left-right direction, and a ratio between axial-perpendicular spring constants in the up-down direction and the left-right direction, for the case where the inclination angle α of the inclined surface 40 is configured to be 0° in the suspension bush without the large-diameter part 20. In FIG. 5, the up-down spring property and the left-right spring property indicate the axial-perpendicular spring constants in the up-down direction and the left-right direction as ratios with respect to the axial-perpendicular spring constant in the up-down direction in the case where the inclination angle α of the inclined surface 40 is 0°.

According to FIG. 5, the suspension bush 10 with the large-diameter part 20 had an axial-perpendicular spring constant in the up-down direction that was approximately 1.5 times and an axial-perpendicular spring constant in the left-right direction that was approximately 1.6 times, compared to the suspension bush without the large-diameter part 20. Thus, it has also been confirmed by measurement tests that, by adopting the inner shaft member 12 including the large-diameter part 20, it is possible to obtain large axial-perpendicular spring constants, and particularly, it is possible to set a large spring constant in the radial direction (left-right direction) off the through holes 30 and 30 in which high spring properties are required.

Further, according to FIG. 5, it has also been confirmed that, in the suspension bush with the large-diameter part 20, within the range 0° to 20° of the inclination angle α of the inclined surface 40, the spring ratio increases as the inclination angle α increases, and the spring ratio is larger in the case where the inclined surface 40 is provided (α=5, 10, 15, 20), compared to the case where the inclined surface 40 is not provided (α=0). Thus, it has also been clarified by actual measurement results that, by providing the large-diameter part 20 of the inner shaft member 12 and the inclined surface 40 of the through hole 30, it becomes possible to set a large ratio between the spring constants in the up-down direction and the left-right direction.

Although the embodiment of the disclosure has been described above in detail, the disclosure is not limited to the specific descriptions thereof. For example, in the embodiment described above, a pair of through holes 30 and 30 are provided on both radial sides of the inner shaft member 12, but the through hole 30 may also be provided as one through hole 30 only at one spot in the circumferential direction, or three or more through holes 30 may also be provided. Further, in the case where multiple through holes 30 are formed, it may be sufficient if the inclined surface 40 of the circumferentially opposing inner surface 38 is provided at at least one of the multiple through holes 30, without the need to be provided at all the through holes 30.

The inclination angle of the inclined surface 40 does not necessarily have to be constant over the entire inclined surface 40, and may also change gradually or stepwise in the axial direction at at least a part in the axial direction.

The inclined surface 40 does not necessarily have to be provided on both axial sides, and may also be provided on one axial side only. Further, in the case where the inclined surfaces 40 and 40 are provided on both axial sides, the inclined surfaces 40 and 40 may also have inclination angles, axial lengths, longitudinal cross-sectional shapes, etc. different from each other.

The inclined surface 40 does not necessarily have to be provided at both of the circumferentially opposing inner surfaces 38 and 38 of the through hole 30, and may also be provided at only one of the circumferentially opposing inner surfaces 38. As can also be learned from this, the circumferentially opposing inner surfaces 38 and 38 of the through hole 30 may also have shapes different from each other.

The axial end of the inclined surface 40 of the through hole 30 may be located off from the inner shaft member 12 toward the lateral side (left and right outer sides) in a projection in the radial direction (up-down direction) in which the through hole 30 is located. Furthermore, a portion at which the opposing surface distance in the circumferential direction is minimum between the circumferentially opposing inner surfaces 38 and 38 of the through hole 30 may be located off from the inner shaft member 12 toward the lateral side in a projection in the radial direction in which the through hole 30 is located. Further, the through hole 30 may be provided at a position overlapping with the inner shaft member 12 in a projection from the lateral side (projection in the left-right direction).

The distance between the radially opposing inner surfaces 32 and 32 of the through hole 30 may also change in at least one of the circumferential direction and the axial direction. For example, it is also possible to provide a stopper protrusion that protrudes into the through hole 30 in the radial direction. Further, the inner circumferential rubber 34 provided on the inner circumferential side of the through hole 30 may also have a thickness dimension that changes in the circumferential direction, and a cross-sectional shape does not necessarily have to be constant in the circumferential direction.

The above embodiment has illustrated a structure in which the large-diameter part 20 is integrally formed in the inner shaft member 12. However, for example, with respect to an inner main body in a straight shape extending with a substantially constant cross-section, by fixing an annular member formed separately from the inner main body into an external fitting state, it is also possible to configure the inner shaft member including a large-diameter part by a combination of two components including the inner main body and the annular member. In that case, for example, it is also possible to make the materials of the inner main body and the annular member different, such as forming the inner main body with metal and forming the annular member with synthetic resin. For example, if the annular member is directly molded on an outer circumferential surface of the inner main body, it is also possible to omit the attachment work of attaching the annular member to the inner main body. The inner shaft member (inner main body) is not necessarily limited to a hollow tubular shape, and may also be a solid rod shape or the like, for example.

In the case where the inclined surfaces 40 and 40 are provided on both sides in the axial direction in the through hole 30, a non-inclined surface that is not inclined with respect to the axial direction may also be provided between the inclined surfaces 40 and 40 in the axial direction. However, in the case where such a non-inclined surface is provided at an approximately central portion in the axial direction, for example, the axial length of the non-inclined surface is preferably configured to be 30% or less, and more preferably 20% or less, of the entire axial length of the through hole 30.

Further, the inclined surface 40 may also be provided at an axial position off from the large-diameter part 20 of the inner shaft member 12 toward the axial outer side, and the entire inclined surface 40 may also be located on the outer circumference of the small-diameter part 18. However, the inclined surface 40 preferably rests on a bulge portion (both axial side portions of the large-diameter part 20) that is configured with a diameter at least slightly larger than the small-diameter part 18 of the inner shaft member 12, and at least a part of the inclined surface 40 overlaps with the large-diameter part 20 in a projection in the axial-perpendicular direction.

What is claimed is:

1. A tubular vibration damping device comprising an inner shaft member and an outer tube member connected by a main body rubber elastic body, wherein
the inner shaft member is provided with a large-diameter part having an outer diameter dimension that is configured to be large at an axial middle portion,
the main body rubber elastic body is provided with a through hole penetrating in an axial direction and extending for a predetermined length in a circumferential direction, and
the through hole has circumferentially opposing inner surfaces at least one of which is provided with an inclined surface that expands such that a circumferentially opposing surface distance gradually increases toward an axial opening part of the through hole.

2. The tubular vibration damping device according to claim 1, wherein the circumferentially opposing surface distance between the circumferentially opposing inner surfaces in the through hole is configured to be minimum at an axial central portion and gradually increases toward both axial sides.

3. The tubular vibration damping device according to claim 1, wherein at an axial position at which the circumferentially opposing surface distance between the circumferentially opposing inner surfaces in the through hole is minimum, the circumferentially opposing surface distance between the circumferentially opposing inner surfaces is configured to be smaller than an outer diameter of the inner shaft member.

4. The tubular vibration damping device according to claim 3, wherein the circumferentially opposing surface distance between the inclined surfaces of the circumferentially opposing inner surfaces in the through hole is configured to be smaller than the outer diameter of the inner shaft member.

5. The tubular vibration damping device according to claim 1, wherein the through hole does not overlap with the inner shaft member in an axial-perpendicular projection from a lateral side.

6. The tubular vibration damping device according to claim 1, wherein the main body rubber elastic body is provided with a pair of the through holes on both sides in a first radial direction with respect to the inner shaft member, and is configured as a solid structure in a second radial direction orthogonal to the first radial direction.

7. The tubular vibration damping device according to claim 1, wherein a radially opposing surface distance between radially opposing inner surfaces in the through hole is configured to be constant.

8. The tubular vibration damping device according to claim 1, wherein a thickness dimension of a portion of the main body rubber elastic body located on an inner circumferential side of the through hole is configured to be constant in the circumferential direction.
